(19) United States
(12) Patent Application Publication
(10) Pub. No.: US 2007/0219811 A1
(43) Pub. Date: Sep. 20, 2007

(54) Method for using an internet-based CRM application to create an on-line leads marketplace

(76) Inventors: John Sung Kim, Dublin, CA (US); Andrew Veliath, Emeryville, CA (US); Maad Abu-Ghazalah, Pacifica, CA (US)

Correspondence Address: Maad Abu-Ghazalah, P.O. Box 1219, Pacifica, CA, 94044, US

(21) Appl. No.: 11/378,213

(22) Filed: Mar. 16, 2006

(51) Int. Cl. G06Q 10/00; G06Q 30/00

(52) U.S. Cl. 705/1

(57) ABSTRACT

A method for creating a viable on-line leads marketplace is described whereby an internet-based CRM application is used for gathering metrics on leads which can then be used by potential buyers to objectively evaluate the quality of the leads before bidding on their purchase.

### BACKGROUND OF THE INVENTION

1. Field of the Invention

The present invention relates to an improved data processing system, and, in particular, to a business practice.

2. Description of Related Art

A central function of any sales person is to maintain contact information for potential sales. CRM software applications such as SalesForce.com®, are widely used by salespeople to track this information. Although CRM applications store basic contact information, they have evolved to track broader sales-related information, such as the source of the contact, when it was obtained, and whether any sales have been made to the contact. Since the purpose of maintaining this information is to lead to future sales, the contact information is also called a “lead”.

With the increased popularity of the internet, on-line marketplaces have also become popular for buying and selling items on-line. However, no popular on-line marketplace exists for buying and selling leads across multiple vertical industries, even though leads are very valuable.

One reason for this is that potential buyers have little way of evaluating the quality of leads before purchasing them. An item, such as a chair, can be auctioned fairly easily on-line because potential buyers can examine a photograph of the chair to evaluate its quality and determine how much to bid to purchase it. But sales leads can vary in their value depending on the likelihood they will lead to an actual sale. Without the ability to objectively, i.e. without relying on the judgment of the seller, determine the value of a lead, it is unlikely there would be many bidders for leads in an on-line auction.

### SUMMARY OF THE INVENTION

A method for creating a viable on-line leads marketplace is described whereby an internet-based CRM application is used for gathering metrics on leads which can then be used by potential buyers to objectively evaluate the quality of the leads before bidding on their purchase.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which a Sales Portal can be created, utilizing a CRM to create an on-line leads marketplace.

FIG. 2 is a flow chart depicting the process through which a leads in a CRM can be leased in an on-line leads marketplace.

FIG. 3 is an example of the layout of a contact web page.

FIG. 4 is a diagram depicting how fields in a contact page can be mapped to the fields in a Sales Portal database.

FIG. 5 is a flow chart depicting the process through which a Sales Portal can use subscriber's profiles to identify and notify potential buyer's when leads are posted for sale in an on-line leads marketplace.

FIG. 6 is a flow chart depicting the process through which subscribers to a Sales Portal can browse the profiles of other subscribers to identify and notify potential buyers or sellers of leads in an on-line leads marketplace.

### DETAILED DESCRIPTION OF THE INVENTION

The current invention is a method for using an internet-based CRM application to create an on-line leads marketplace. A sales portal (SP) is created on the internet requiring subscription for access. The SP comprises three applications running on an internet server, an SP CRM application, an SP auction application and an SP advertising application. The CRM application gathers leads information, the auction application administers an on-line auction to sell or lease the leads, and the advertising application facilitates the buyer or lessor's ability to use the leads.

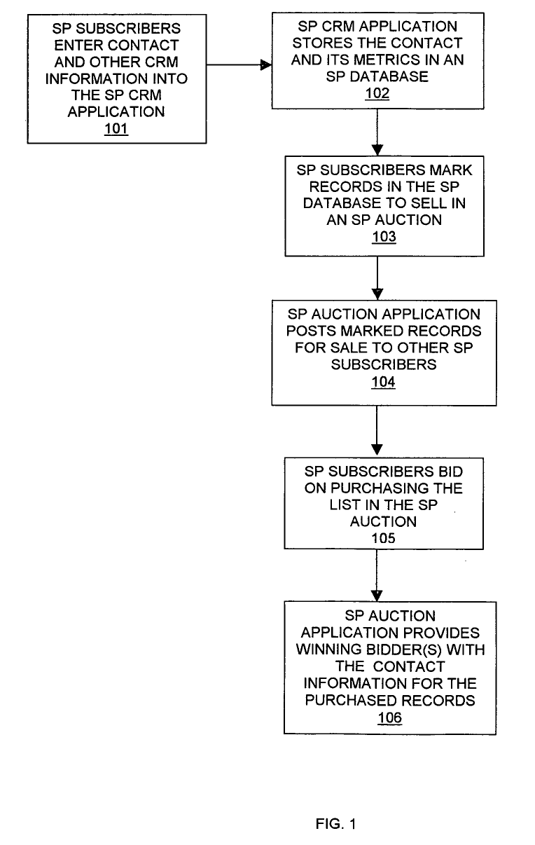

Referring to FIG. 1, subscribers to the SP use the SP CRM application to enter contact information, such as name, phone number and e-mail address, and other information typically stored in a CRM application, such as the source of the contact, when it was created, when it was last updated or used and whether a sale was made to the contact (Step 101). The CRM information is called the “metrics” for the contact. The SP CRM application stores the contact and its metrics into a SP database (step 102).

SP subscribers are provided the ability to mark one or more of their own records in the SP database for sale (step 103). The SP auction application then compiles the marked records into a list and posts the list for sale. The SP auction application provides potential buyers access to all the metrics of the leads but hides the contact information, such as the name, phone number and e-mail address (step 104). In one embodiment, the SP auction application uses the metrics of the leads stored by the CRM application as well as information about the SP subscriber offering the contacts for sale in creating a rating of the quality of the list of leads. For example, the SP auction application can consider the date the contacts were added to the SP CRM application and the last time it was updated in determining the rating of the list of leads.

The SP auction application then posts the list for sale to other SP subscribers (step 105). The SP subscribers can view metrics for the contacts in the list as well as the SP auction application's rating (if one has been calculated) and bid on purchasing the list. The SP auction application then provides the contact information for the records in the list to the winning bidder(s) (step 106).

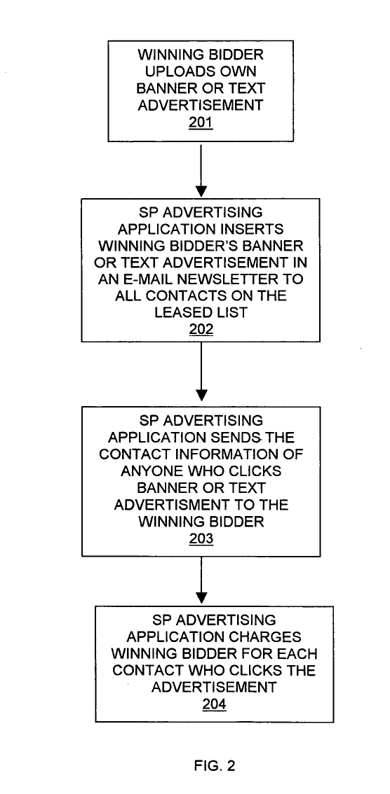

In one embodiment, the SP auction is for the lease of the contacts instead of or in addition to their sale. The method for this embodiment is as described in FIG. 1 but the records in step 103 are marked by the SP subscriber for lease rather than for sale. Also, the final step in FIG. 1 is replaced in this embodiment. In its place, referring now to FIG. 2, after the SP auction application determines the winning bidder, the winning bidder uploads his or her banner or text advertising to the SP advertising application (step 201). Alternatively, the bidders upload their banner or text advertisement to the SP advertising application prior to the completion of the auction.

The SP advertising application dynamically inserts a hyperlink in the winning bidder's advertisement. The hyperlink directs any contact who clicks on the advertisement to a page controlled by the SP advertisement application (step 202). The SP advertising application then inserts the winning bidder's banner or text advertisement in an e-mail Newsletter and sends the e-mail newsletter to the e-mail addresses of all the contacts in the leased list (step 203). The SP advertising application also dynamically inserts the record number each contact receiving the e-mail newsletter as a parameter in the hyperlink (step 204).

If a contact clicks the winning bidder's advertisement, the SP advertising application uses the parameter in the advertisement hyperlink to identify the contact's record in the SP database (step 205). The SP advertisement application then sends the contact's complete information to the winning bidder (step 206). In one embodiment, the SP advertising application or SP auction application then charges the winning bidder for each contact the clicks the winning bidder's advertisement. In another embodiment, the winning bidder is charged a flat fee regardless of how many contacts click his or her advertisement.

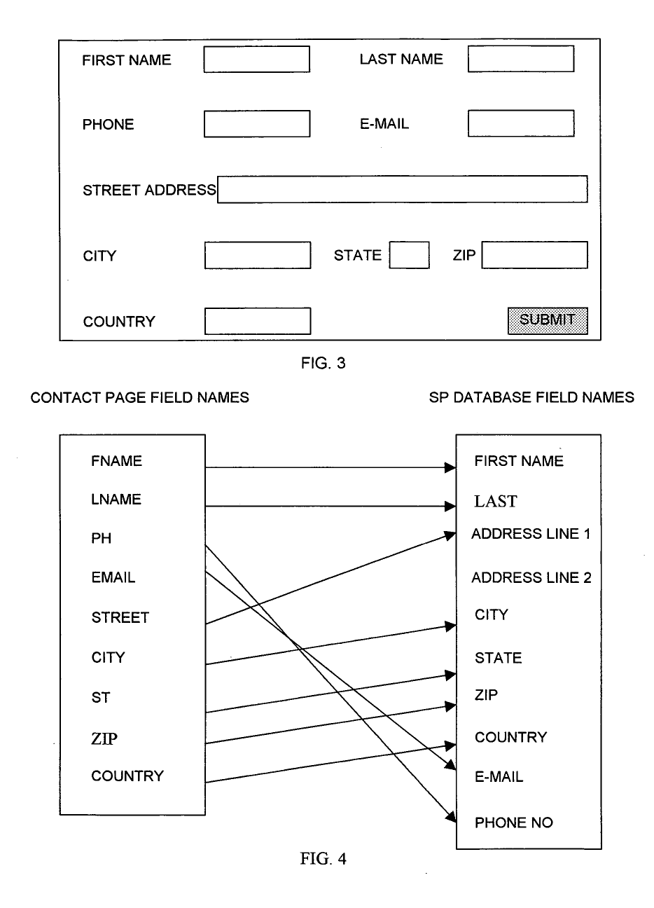

In another embodiment, the SP CRM application automatically feeds contact information from the SP subscriber's web site into the SP CRM application thereby expediting the process of entering contact information into the SP CRM application. The SP subscriber creates a personalized web page for obtaining contact information, called a “contact page”. An example of a contact page is shown in FIG. 3. The contact page can be hosted by the SP subscriber or the SP host.

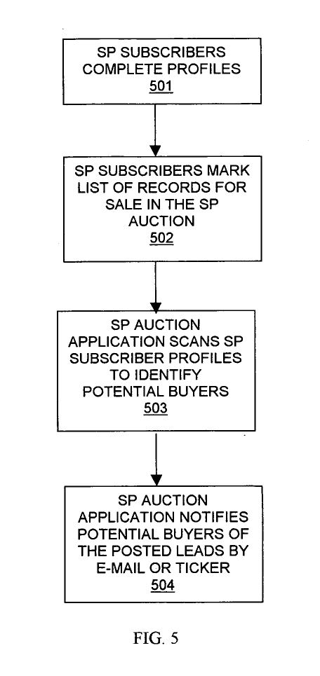

The SP Subscriber then uploads the contact page to the SP CRM application. The SP CRM application identifies and displays the field names in the contact page. The CRM application also displays the field names in the SP database and allows the SP subscriber to map each contact page field name to an SP database field name. For example the contact page may use the field name “FName” for the field in which the contact page visitor enters his or her first name, and the SP database may use the field name “First Name” to store the first name of contacts. The SP subscriber would then use the CRM application to map the contact page field name “FName” to the SP database field name “First Name” as shown in FIG. 4. The SP subscriber would then map as many fields from the contact page to the SP database fields as appropriate.

The CRM application then stores the mapping information and associates it with the SP subscriber's contact page. In addition, the SP CRM application creates code that is inserted by the SP subscriber in the contact page so that when the contact page visitor submits the contact page, the contact page field values and field names are sent to the SP CRM application.

When the contact page visitor clicks the Submit button, the field names and values are sent to the CRM application. The CRM application then uses the field mapping to automatically store the contact page information in the appropriate fields in the SP database.

In another embodiment, the SP host motivates auction activity by reviewing profiles created by SP subscribers and notifying potential buyers (based on their profile) whenever a list of leads is posted for sale. Referring now to FIG. 5, the SP CRM application provides SP subscribers the ability to enter information about themselves, the type of leads they are interested in buying or leasing, and the types of leads they currently own or expect to own (step 501). This is called the SP subscriber's profile. The SP CRM application stores each SP subscriber's profile in the SP database.

When an SP subscriber marks a list of contacts for sale or lease (step 502), the SP auction application scans the SP subscribers' profiles to identify potential buyers who might be interested in purchasing the list of contacts (step 503). The SP Auction Application then notifies potential buyers of the posted leads by e-mail or ticker (step 504).

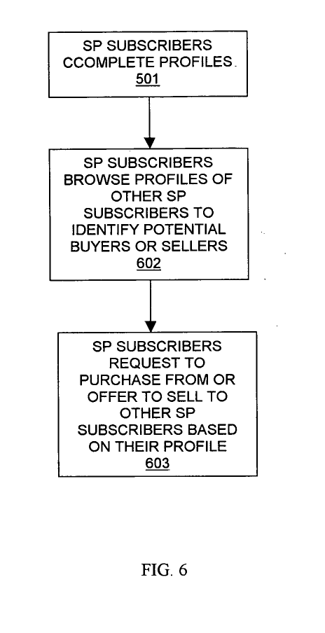

In another embodiment, the SP auction application or SP CRM application provides SP subscribers with the ability to browse or search the profiles of other SP subscribers in order to find potential buyers or sellers of contact lists. Referring now to FIG. 6, the SP subscribers fill out a profile such as the one described in the previous embodiment (step 601). The SP CRM application or SP auction application then allow the SP subscribers to browse profiles of other SP subscribers to identify potential buyers of contacts they own or potential sellers of contacts they would be interested in purchasing (step 602). The SP subscribers then request to purchase from or offer to sell to other SP subscribers based on their profile (step 603). The SP auction application facilitates this process by providing means of communication between SP subscribers for this purpose, such as e-mail notification or ticker. A method for creating a Sales Portal that uses an on-line CRM application to store leads that can be bought and sold in an on-line auction, the computer implemented method comprising:

1. A method for creating a Sales Portal that uses an on-line CRM application to store leads that can be bought and sold in an on-line auction, the computer implemented method comprising the following steps:
A. Creating an internet Sales Portal (SP) that includes a CRM application for subscribers to the SP to track their sales leads.
B. Creating an auction site on the SP and providing an auction application to allow the SP subscribers to buy and sell their leads stored in the CRM application.
C. Displaying metrics about the leads stored in the CRM application such as the age of the lead, its source, and whether it has led to a previous sale, for potential bidders in the auction to review prior to making bids, but not displaying the contact information, such as the name and address.
D. Providing the winning bidder with the contact information of the purchased leads.

2. A method for creating a Sales Portal as in claim 1 further providing objective analysis, such as a rating, of the quality of the leads posted for sale in the auction based on the metrics stored in the CRM application.

3. A method for creating a Sales Portal as in claim 1 further providing the SP subscribers the option of leasing as well as selling their leads in the auction by allowing the winning bidder to upload a banner or text advertisement and including the uploaded advertisement in an e-mailed newsletter and providing the winning bidder the contact information of all recipients who click on the advertisement and charging the winning bidder either for each newsletter recipient who clicks on the advertisement or a flat fee for all the leased records.

4. A method for creating a Sales Portal as in claim 1 further providing the SP subscribers the ability to submit contact information directly to the CRM application from the SP subscribers' web site by mapping the fields on the SP subscribers' contact page to the fields in the CRM database.

5. A method for creating a Sales Portal as in claim 1 further comprising the step of providing the SP subscribers with the option to fill out a profile which the owner of the SP uses to identify and notify (either by e-mail or ticker) SP subscribers who might be interested in purchasing leads when they are posted for sale.

6. A method for creating a Sales Portal as in claim 1 further providing SP subscribers with the ability to browse the profiles of other SP subscribers to identify potential buyers or sellers of leads and further providing the SP subscribers the ability to communicate directly with other SP subscribers in order to offer to sell or request to purchase leads based on the SP subscriber's profile.
